(19) United States
(12) Patent Application Publication
(10) Pub. No.: US 2025/0315614 A1
(43) Pub. Date: Oct. 9, 2025

(54) ITERATIVE KNOWLEDGE GENERATION VIA REPEATED STUDYING

(71) Applicant: Maplebear Inc., San Francisco, CA (US)

(72) Inventors: Spencer Lee Cohen, Wilmington, NC (US); Benjamin Bernard, Brier, WA (US)

(21) Appl. No.: 19/173,481

(22) Filed: Apr. 8, 2025

Related U.S. Application Data
(60) Provisional application No. 63/631,072, filed on Apr. 8, 2024.

(51) Int. Cl. G06F 40/20; G06N 20/00

(52) U.S. Cl. CPC G06F 40/20; G06N 20/00

(57) ABSTRACT

A multi-generation RAG process generates a first-generation prompt for input to LLMs. The first-generation prompt may specify a concept, raw data, and a first-generation request to draw inference of information related to the concept using the raw data. The process provides the first-generation prompt for execution by the LLMs and receives a first-generation response. The process iteratively updates the inference of information using the LLMs. The iteratively updating includes using the inference of information related to the concept that are received from a previous-generation response as contextual information for a subsequent-generation RAG process. The process receives a subsequent-generation response generated by executing the LLMs and stores the iteratively updated inference of information related to the concept for retrieval by the machine-learned language model.

### CROSS REFERENCE TO RELATED APPLICATIONS

This application claims the benefit of U.S. Provisional Patent Application Ser. No. 63/631,072, filed Apr. 8, 2024, which is incorporated by reference herein in its entirety.

### BACKGROUND

An online system is an online platform that provides one or more online services. An example of an online service may include allowing users to perform transactions associated with items. The items may represent physical entities stored in a physical location, such as groceries. A user can place an order for purchasing items from participating retailers via the online system, with the shopping being done by a picker. After the personal shopper or picker finishes shopping, the order is delivered to the user's address.

In some embodiments, the online system uses a retrieval augmented generation (RAG) process which utilizes both retrieval-based and generation-based approaches to enhance text generation tasks. By incorporating retrieval-based techniques, RAG models can leverage external knowledge sources to enhance the quality and relevance of generated text. However, the RAG models lack the granular and nuanced understanding of disparate data elements as well as a thorough contextual understanding. The RAG models are not efficient in discerning the relationship between disconnected facts or drawing significant conclusions about their contexts, thus leading to inaccuracies in the output responses. Additionally, the volume and size of data that a RAG model can process each iteration is limited, which further limits the scalability of the RAG model.

### SUMMARY

In accordance with one or more aspects of the disclosure, the techniques described herein relate to systems and methods for performing a multi-generation retrieval augmented generation (RAG) process. In particular, the system performs an inference task in conjunction with the model serving system or the interface system to iteratively update inference of information related to a concept. The first-generation prompt may specify at least a concept, raw data from one or more source documents, and a first-generation request to draw inference of information related to the concept using the raw data from the one or more source documents. The system may provide the first-generation prompt to a model serving system for execution by a machine-learned language model. The system may receive a first-generation response generated by executing the machine-learned language model on the first-generation prompt. The system may iteratively update the inference of information related to the concept using the machine-learned language model. In some embodiments, the system may update the inference of information by generating a subsequent-generation prompt for input to the machine-learned language model. The subsequent-generation prompt may specify at least the concept in the first-generation prompt, the raw data from the one or more source documents, the inference of information related to the concept that are received from a previous-generation response, and a subsequent-generation request to update the inference of information related to the concept using at least the inference of information related to the concept that is received from a previous-generation response. The system may store the iteratively updated inference of information related to the concept for retrieval by the machine-learned language model.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for training a multi-generation RAG process, in accordance with one or more embodiments.

### DETAILED DESCRIPTION

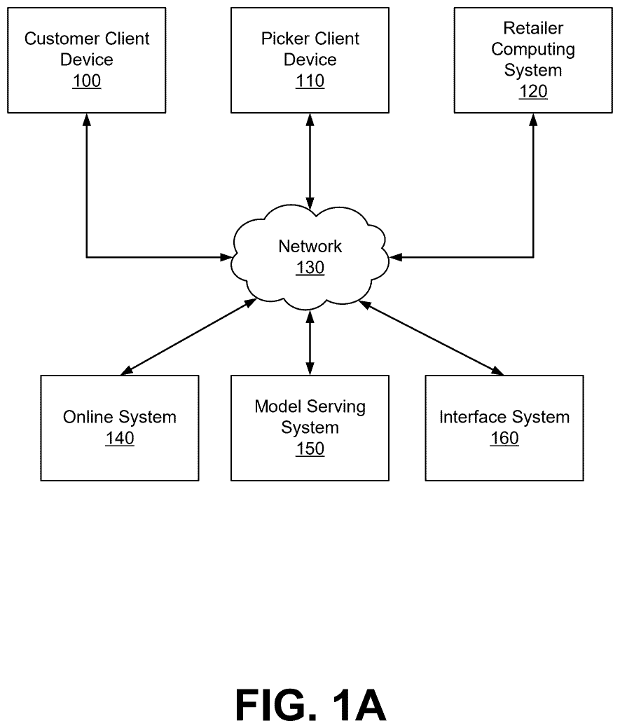

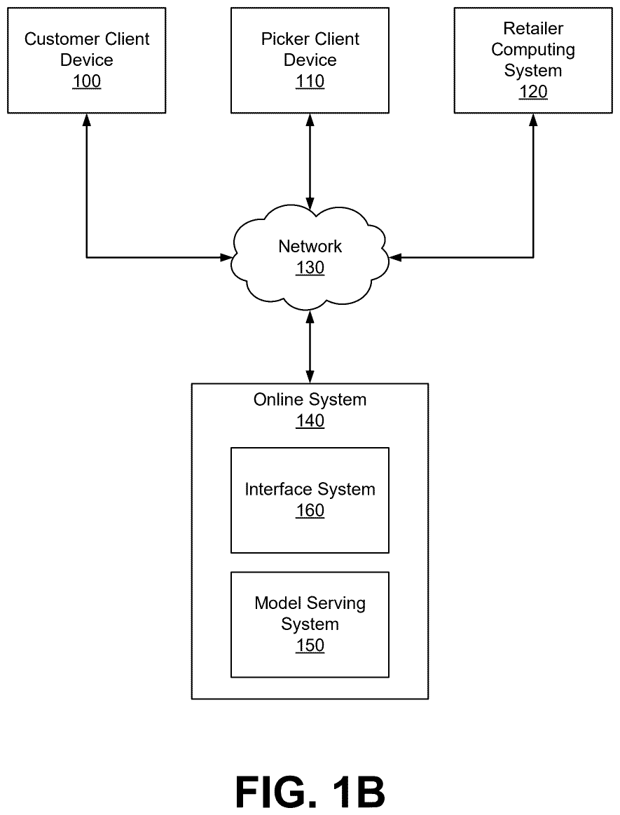

FIG. 1A illustrates an example system environment for an online system 140, in accordance with one or more embodiments. The system environment illustrated in FIG. 1A includes a customer client device 100, a picker client device 110, a retailer computing system 120, a network 130, an online concierge system 140, a model serving system 150, and/or an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in

some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, the online system 140, the model serving system 150 and/or the interface system 160 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

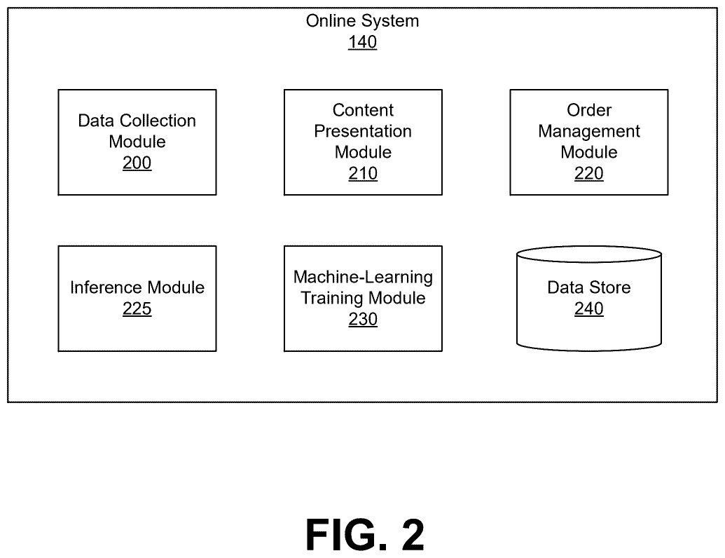

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In some embodiments, the transformer architecture may have an encoder-decoder architecture and includes a set of encoders coupled to a set of decoders. An encoder or decoder may include one or more attention operations.

While a LLM with a transformer-based architecture is described as one example embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

This disclosure provides a multi-generation RAG with a graph-structured knowledge base. In traditional RAG systems, the model retrieves relevant documents and generates a response in a single step, which can lead to incomplete or inaccurate inferences. Additionally, the traditional RAG often lacks persistent memory across different inference steps. Each query is treated as an independent request, which can lead to loss of context and redundant processing. The multi-generation RAG disclosed herein overcomes this limitation by iteratively refining its inferences. Each new generation builds upon the previous one, allowing the system to correct errors, add missing details, and develop deeper insights over time. The multi-generation RAG retains contextual knowledge by incorporating previous inferences into subsequent iterations. In this way, the system remains aware of prior insights, reducing inconsistencies and improving coherence in generated responses. The multi-generation RAG provides an iterative approach that reduces redundant computations, leading to faster inference times and lower processing costs. By focusing computational efforts on updating relevant portions of the response, the multi-generation RAG improves efficiency while maintaining high-quality, contextually rich outputs.

In one or more embodiments, the online system 140 performs a multi-generation retrieval augmented generation (RAG) process to draw inferences about disparate facts and use the inferences as context information for RAG. The multi-generation RAG includes multiple iterations of studying and synthesizing raw knowledge from source documents into searchable “facts” and/or “concepts.” In each step, the output of the previous generation serves as contextual information, creating a robust and self-evolving system. Specifically, the multi-generation RAG follows a twofold training process. The first phase includes using LLM(s) to interpret raw data in the source documents. In some embodiments, the raw data may be organized into a coherent data structure that is retrievable and searchable by a model serving system 150. The second phase includes iterative generations, where each iteration augments the LLM(s) with an expanded knowledge look-up from the previous generation, enabling the LLM(s) to draw inferences amid diverse facts.

For example, in the second phase, during each generation, the online system 140 prepares a prompt for input to the model serving system 150. The prompt may include a user query/concept, the raw data from source documents, contextual information drawn from preceding generations, and relevant context inferred based on prior generations. In some embodiments, the prompt is a comprehensive package of diverse data points and instructions which is then submitted to the LLM. The LLM processes the prompt and generates a response. The online system 140 receives the response to the prompt from the model serving system 150 based on execution of the machine-learned model using the prompt. In this way, the response is not solely a forthright answer, but a well-rounded response factoring in the connections between disparate facts.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, oftentimes, the amount of information in the external data exceeds prompt size limitations configured by the machine-learned language model. The interface system 160 can resolve prompt size limitations by generating a structured index of the data and provide data connectors to external data sources.

The disclosed method integrates the multi-generation RAG with a graph-structured knowledge base in which information is interconnected and context-dependent. The computing system benefits from context-aware retrieval, improved inference accuracy, structured reasoning, and efficient knowledge updates. The iterative process enables knowledge to propagate through this network, leading to better contextual understanding. This combination enhances scalability, multi-hop reasoning, and explainability, making it a powerful approach for handling complex, evolving information landscapes.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, an inference module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The inference module 225 performs a multi-generation RAG process. The process may include a twofold training process or any other multifold training process. In the first phase, the inference module 225 may utilize LLMs to interpret raw data in source documents. In some embodiments, the inference module 225 may pre-process the raw data in the source documents, and/or related user queries. For example, the raw data may be unstructured text or other forms of data, and the inference module 225 may pre-process the raw data via tokenization, normalization, entity recognition, etc., and transform the raw data into a format applicable for retrieval and analysis. In one instance, the inference module 225 may identify the terms in the raw data and generate one or more embeddings for representing the terms, the raw data, and/or the corresponding source documents. The generated embeddings may be used in the RAG process via vector search and the data represented by the retrieved embeddings may be used as contextual information for LLMs.

In some embodiments, the inference module 225 may generate a first-generation prompt using the raw data (and/or the pre-processed raw data) for input to an LLM. In one example, the first-generation prompt may specify at least a concept, raw data from one or more source documents, and a first-generation request to draw inference of information related to the concept using the one or more source documents. The inference module 225 may provide the first-generation prompt to a model serving system 150 for execution by the LLM. The LLM may be tasked with understanding the semantics of the raw data and generating meaningful representations that capture the underlying knowledge contained within. For example, the inference module 225 may utilize contextual embeddings to enable the LLM to grasp the nuances and relationships present in the raw data.

In some embodiments, the inference module 225 may receive a first-generation response generated by executing the LLM on the first-generation prompt. The first-generation response may include the inferred information related to the concept that are inferred from the raw data in the one or more source documents. In some implementations, the inferred information may be organized into a coherent data structure so that the inferred information may be retrieved and searched by the model serving system 150. The inferred information may be stored as “knowledge base” in the data store 240. In some embodiments, the knowledge base may be logically structured or represented as a graph of information, where data is interconnected rather than isolated. The graph may include a plurality of nodes representing discrete pieces of knowledge, such as concepts, topics, or symbols in code, and a plurality of edges that describe the relationships or dependencies between nodes. In some embodiments, the graph of knowledge base may be a vector database; alternatively, the graph of knowledge base may be a structured key-value store.

The structured graph may include dynamic and contextual representations of information so that the inference module 225 may retrieve and understand data based on its relevance rather than treating it as standalone units. With a graph structure, the information may be inherently dependent on context. In some cases, understanding one concept (e.g., Context A) often requires knowledge of another (e.g., Context B), which in turn relies on Context C. These relationships do not always follow a simple, linear progression but instead form a network of interdependencies. For example, in code understanding, a function may rely on another function, which in turn depends on specific variables or constants, forming a function dependency graph. In document retrieval, one article may reference multiple others, creating a web of citations and related topics. Using a graph structure, the inference module 225 may infer conceptual relationships between documents, dynamically linking similar ideas even if they are not explicitly connected. This networked approach provides a more comprehensive and context-aware representation of information.

In the second phase of the multi-generation RAG process, the inference module 225 may update the inferred information related to the concept. The second phase may include multiple generations of a training process that accumulates and aggregates the knowledge base. This process essentially enables the LLMs to draw inferences and establish connections between varied pieces of information that may previously appear unrelated. The inferred information from the previous generations provides evolving context information that supplements the LLMs interpretation in the subsequent generations.

The multiple generations may form an iterative process in which information propagates through the graph of the knowledge base. For instance, in initial generations, the inference module 225 may identify direct relationships between nodes, such as determining which function calls another in a codebase. In the subsequent generations, the inference module 225 may expand the context by incorporating indirect relationships, such as understanding that a function's dependencies also have their own dependencies. With each additional iteration, the context deepens, allowing the inference module 225 to not only retrieve related information but also infer higher-level and/or more complex relationships. In this way, the inference module 225 may perform an iterative RAG on a given concept by effectively spreading through the network of the graph rather than being confined to isolated data points.

In some embodiments, the graph functions as a vector database, which organizes and retrieves information based on semantic similarity rather than predefined relationships. The inference module 225 first stores raw data in a format for vector-based search. When a query is received, the inference module 225 searches for relevant data segments by comparing vector embeddings. Once relevant context is identified, the inference module 225 provides the identified relevant context to an LLM, which processes the information, infers deeper relationships, and expands upon the knowledge iteratively. In an iterative process, the previously generated responses are integrated into future queries, allowing the inference module 225 to continuously refine and enhance its contextual understanding over time.

In cases for code analysis, the graph may include a key-value store that assigns keys to specific identifiers, such as symbol names, file paths, or line numbers, while the corresponding values contain previously generated descriptions or explanations. The key-value store structured graph may be used to organize and access structured code documentation and dependencies. During information retrieval, the inference module 225 may use the key-value store structured graph to perform exact matches.

In some embodiments, the graph may be an explicit graph that includes directly represented structures. The relationships between nodes (e.g., pieces of information) are explicitly defined. For example, for hyperlinks between documents, if one document links to another, the inference module 225 can recognize and store this connection as a graph structure in the graph. In some embodiments, the graph may be an implicit graph where the conceptual relationships are not explicitly defined in the data but can be inferred. For instance, in code analysis, symbols such as function calls, variable references, and dependencies create an interconnected structure, even if these links are not directly encoded in a traditional graph format. Semantic graphs may be built dynamically based on related concepts retrieved through the RAG. Instead of being predefined, these relationships are generated on the fly by the LLM, which identifies conceptual similarities between data points and constructs a graph of related ideas.

In some implementations, at each generation, the inference module 225 may generate a prompt to input to the LLMs. For example, the inference module 225 may identify a concept from the first generation in the first phase of the multi-generation RAG process, and construct a prompt that specifies at least the concept, the raw data from the source documents, and contextual information retrieved from previous generations. The contextual information may include the inferred information related to the concept that is inferred from the previous generations and/or the knowledge base built from the previous generations. In some embodiments, the prompt may further include other pertinent context inferred from the accumulated knowledge base. The prompt may further include a request to update the inference of information related to the concept using at least the inferred information related to the concept that are inferred from the previous generations as the contextual information.

The inference module 225 provides the generated prompt to the model serving system 150 for execution by the LLMs. The inference module 225 receives a response generated by executing the LLM for each generation. In some embodiments, the inference module 225 may store the received response in each generation in the knowledge base for retrieval in an RAG process. In some embodiments, the inference module 225 may update the existing knowledge base with the response from the current generation. Updating the existing knowledge base may include adding, deleting, modifying, etc., the information/data currently stored in the knowledge base. In some embodiments, the inference module 225 may only store the most recent response, e.g., the response from the current generation, and use the inferred information included in the current response for retrieval in an RAG process.

The inference module 225 may use the inferred information from the multi-generation RAG process to generate a response to a user query via the execution of the LLM. For example, when receiving a user query, the inference module 225 may identify a target concept that is related to the user query, and generate a prompt for input to the LLM. The prompt may specify at least the user query, the target concept, stored inference of information related to the target concept, and a request to generate a query response to the user query using at least the stored inference of information related to the target concept. The inference module 225 provides the prompt to the model serving system 150 for execution by the LLM. The LLM may include a RAG process that retrieves the stored inference of information related to the target concept as contextual information for executing the LLM. The inference module 225 receives a response from the model serving system 150 by executing the LLM on the prompt and presents/includes the response as the query response to the user query. In some embodiments, the query response to the user query may include inferred information related to the concept and may be used to update the stored inference of information. In this way, the multi-generation RAG training process is integrated with the application of the user query-response process.

In some implementations, the first phase of the multi-generation RAG process may be similar to a generic RAG process used by an LLM. For example, during the first phase, when the inference module 225 receives a user query, e.g., “What are the steps for rebooting the XYZ server infrastructure?” The inference module 225 may identify the concept as “reboot,” and generate a prompt that includes the user query, raw data related to the XYZ server system, and a request to generate a response to the user query using the raw data. Because the generic RAG process retrieves the raw data directly and uses it as the contextual information, the RAG does not obtain information/connections that humans would infer as the contextual information for execution of the LLMs. The generated response might not be depth-oriented or contextually rich.

With the multi-generation RAG process, the inference module 225 generates prompts to infer connections between disparate facts and obtains inferred information related to a concept. For instance, related information may be inferred that certain applications running on the XYZ server require safe shutdown before the reboot, or perhaps a backup process must be completed to ensure data integrity. The multi-generation RAG process identifies such interrelated elements, adding another layer of relational awareness to its existing knowledge base. As the generations proceed, the multi-generation RAG process may further learn interdependence of the server applications, necessary back-up procedures, or time-critical steps. Each of these elements are interconnected and imperative for the successful server reboot, forming the context for the subsequent generations.

When receiving a subsequent same user query, the inference module 225 may generate a prompt that includes the inferred information related to the concept “reboot,” which is learned in the previous generations. For example, the inference of information may include specific intricacies to keep in mind while rebooting the XYZ server infrastructure. The corresponding response output by the LLM by inputting this response might not only include the steps of rebooting the XYZ server, but also include, for example, “Before shutting down the backup process, ensure all backup jobs are completed. . . . Rebooting and restarting the XYZ server are two different processes, rebooting refers to . . . ” In this way, the multi-generation RAG fosters results in more comprehensive and targeted responses. The multi-generation RAG process does not merely provide a response that answers a query but also provides a comprehensive understanding of the information, linked to the context built up over generations.

In some embodiments, the inference module 225 may use the multi-generation RAG to perform code review and analysis. A major challenge in code review is that analyzing a function in isolation often results in a shallow, literal interpretation. Without broader context, an LLM may simply describe what the function does step by step, without explaining why it exists or how it fits into the system. The inference module 225 may build a graph of the knowledge base (e.g., RAG database) that is structured with a key-value store, e.g., symbol names and file locations. Symbols may refer to function names, variable names, constants, types, etc. Rather than listing each separately, they are collectively referred to as symbols. The graph stores relationships using keys that may include a file path, a line number, a file path, and a symbol name. When querying a symbol, the inference module 225 retrieves all instances of that symbol across the entire graph so that the LLM may infer deeper connections by leveraging previously generated descriptions. By retrieving related symbols (such as functions it calls, constants it references, and its interactions with other components), the LLM can generate a richer, more meaningful explanation. Instead of just stating what the function does, it can explain why it is important, how it fits into the larger architecture, and what dependencies it has.

In some implementations, the inference module 225 may use an iterative process in code analysis. For instance, in initial iterations, the inference module 225 may use the multi-generation RAG to generate descriptions for all functions and symbols individually. In subsequent iterations, the inference module 225 may use the previously generated descriptions as context information to deepen the understanding of interconnected functions and independencies. For example, if a function calls another function that references a constant defining database table names, the second iteration would connect those relationships, forming a graph of dependencies. Over time, this iterative approach helps “bleed” information across the graph so that each function is understood in its broader context rather than just in isolation.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data. In some embodiments, the data store 240 may store the knowledge base in a structured graph, such as vector database, key-value store, etc.

With respect to the machine-learned models hosted by the model serving system 150, the machine-learned models may already be trained by a separate entity from the entity responsible for the online system 140. In some embodiments, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

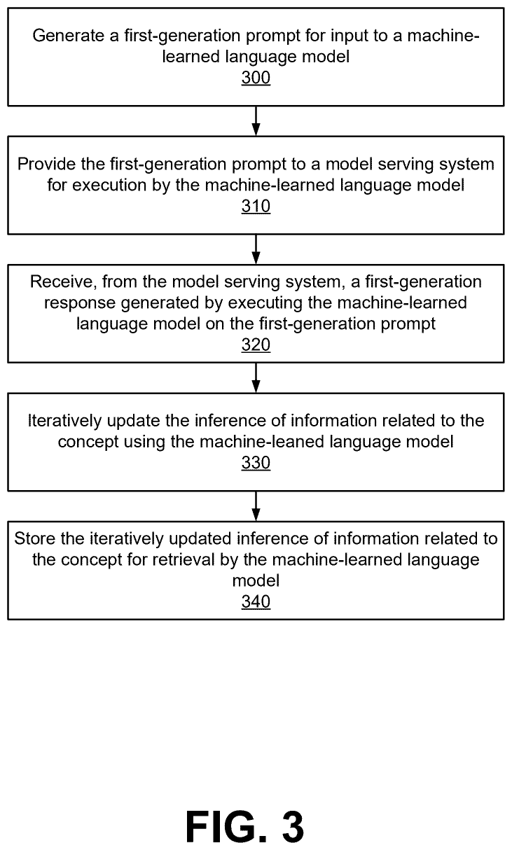

FIG. 3 is a flowchart for a method of training a multi-generation RAG process, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

In some embodiments, the online system 140 may generate 300 a first-generation prompt for input to a machine-learned language model. The first-generation prompt may specify at least a concept, raw data from one or more source documents, and a first-generation request to draw inference of information related to the concept using the raw data from the one or more source documents. The online system 140 may provide 310 the first-generation prompt to a model serving system 150 for execution by the machine-learned language model. The online system 140 may receive 320, from the model serving system 150, a first-generation response generated by executing the machine-learned language model on the first-generation prompt. The online system 140 iteratively updates 330 the inference of information related to the concept using the machine-learned language model. In some embodiments, the online system 140 may update the inference of information by generating a subsequent-generation prompt for input to the machine-learned language model. The subsequent-generation prompt may specify at least the concept in the first-generation prompt, the raw data from the one or more source documents, the inference of information related to the concept that are received from a previous-generation response, and a subsequent-generation request to update the inference of information related to the concept using at least the inference of information related to the concept that is received from a previous-generation response. The online system 140 may provide the subsequent-generation prompt to the model serving system for execution by the machine-learned language model and receive a subsequent-generation response generated by executing the machine-learned language model on the subsequent-generation prompt. The online system 140 may set the subsequent-generation response as the previous-generation response for a next iteration. The online system 140 may store 340 the iteratively updated inference of information related to the concept for retrieval by the machine-learned language model.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
generating a first-generation prompt for input to a machine-learned language model, the first-generation prompt specifying at least a concept, raw data from one or more source documents, and a first-generation request to draw inference of information related to the concept using the raw data from the one or more source documents;
providing the first-generation prompt to a model serving system for execution by the machine-learned language model;
receiving, from the model serving system, a first-generation response generated by executing the machine-learned language model on the first-generation prompt;
iteratively updating the inference of information related to the concept using the machine-learned language model, comprising:
generating a subsequent-generation prompt for input to the machine-learned language model, the subsequent-generation prompt specifying at least the concept in the first-generation prompt, the raw data from the one or more source documents, and the inference of information related to the concept that are received from a previous-generation response and a subsequent-generation request to update the inference of information related to the concept using at least the inference of information related to the concept that is received from a previous-generation response;
providing the subsequent-generation prompt to the model serving system for execution by the machine-learned language model;
receiving, from the model serving system, a subsequent-generation response generated by executing the machine-learned language model on the subsequent-generation prompt; and
setting the subsequent-generation response as the previous-generation response for a next iteration; and
storing the iteratively updated inference of information related to the concept for retrieval by the machine-learned language model.

2. The method of claim 1, further comprising:
receiving, from a client device, a user query;
identifying that the user query is related to a target concept;
generating a prompt for input to the machine-learned language model, the prompt specifying at least the user query, the target concept, stored inference of information related to the target concept, and a request to generate a query response to the user query using at least the stored inference of information related to the target concept as contextual information;
providing the prompt to a model serving system for execution by the machine-learned language model;
receiving, from the model serving system, a response generated by executing the machine-learned language model on the prompt; and
transmitting instructions to the client device to cause presentation of the response including the received query response to the user query.

3. The method of claim 2, wherein the user query comprises a request to perform code analysis.

4. The method of claim 1, wherein iteratively updating the inference of information related to the concept using the machine-learned language model comprises:
retrieving, from a graph-structured knowledge base, inferenced information related to the concept.

5. The method of claim 4, wherein storing the iteratively updated inference of information related to the concept for retrieval comprises:
storing, at the graph-structured knowledge base, the iteratively updated inference of information related to the concept for retrieval.

6. The method of claim 1, further comprising:
identifying terms in the raw data from one or more source documents; and
generating, using the identified terms, one or more embeddings for representing the raw data.

7. The method of claim 6, further comprising:
performing a vector search using the one or more embeddings as context information in execution of the machine-learned language model.

8. A computer program product comprising a non-transitory computer readable storage medium having instructions encoded thereon that, when executed by a processor, cause the processor to perform steps comprising:
generating a first-generation prompt for input to a machine-learned language model, the first-generation prompt specifying at least a concept, raw data from one or more source documents, and a first-generation request to draw inference of information related to the concept using the raw data from the one or more source documents;
providing the first-generation prompt to a model serving system for execution by the machine-learned language model;
receiving, from the model serving system, a first-generation response generated by executing the machine-learned language model on the first-generation prompt;
iteratively updating the inference of information related to the concept using the machine-learned language model, comprising:
generating a subsequent-generation prompt for input to the machine-learned language model, the subsequent-generation prompt specifying at least the concept in the first-generation prompt, the raw data from the one or more source documents, and the inference of information related to the concept that are received from a previous-generation response and a subsequent-generation request to update the inference of information related to the concept using at least the inference of information related to the concept that is received from a previous-generation response;
providing the subsequent-generation prompt to the model serving system for execution by the machine-learned language model;
receiving, from the model serving system, a subsequent-generation response generated by executing the machine-learned language model on the subsequent-generation prompt; and
setting the subsequent-generation response as the previous-generation response for a next iteration; and
storing the iteratively updated inference of information related to the concept for retrieval by the machine-learned language model.

9. The computer program product of claim 8, wherein the instructions encoded thereon that, when executed by the processor, cause the processor to perform steps comprising:
receiving, from a client devices, a user query;
identifying that the user query is related to a target concept;
generating a prompt for input to the machine-learned language model, the prompt specifying at least the user query, the target concept, stored inference of information related to the target concept, and a request to generate a query response to the user query using at least the stored inference of information related to the target concept as contextual information;
providing the prompt to a model serving system for execution by the machine-learned language model;
receiving, from the model serving system, a response generated by executing the machine-learned language model on the prompt; and
transmitting instructions to the client device to cause presentation of presenting the response including the received query response to the user query.

10. The computer program product of claim 9, wherein the user query comprises a request to perform code analysis.

11. The computer program product of claim 8, wherein the instructions to iteratively update the inference of information related to the concept using the machine-learned language model, when executed by a processor, cause the processor to perform steps comprising:
retrieving, from a graph-structured knowledge base, inferenced information related to the concept.

12. The computer program product of claim 11, wherein the instructions to store the iteratively updated inference of information related to the concept for retrieval, when executed by the processor, cause the processor to perform steps comprising:
storing, at the graph-structured knowledge base, the iteratively updated inference of information related to the concept for retrieval.

13. The computer program product of claim 8, wherein the instructions encoded thereon that, when executed by the processor, cause the processor to perform steps comprising:
identifying terms in the raw data from one or more source documents; and
generating, using the identified terms, one or more embeddings for representing the raw data.

14. The computer program product of claim 13, wherein the instructions encoded thereon that, when executed by the processor, cause the processor to perform steps comprising:
performing a vector search using the one or more embeddings as context information in execution of the machine-learned language model.

15. A computer system comprising:
a processor; and
a non-transitory computer-readable storage medium having instructions that, when executed by the processor, cause the computer system to perform steps comprising:
generating a first-generation prompt for input to a machine-learned language model, the first-generation prompt specifying at least a concept, raw data from one or more source documents, and a first-generation request to draw inference of information related to the concept using the raw data from the one or more source documents;
providing the first-generation prompt to a model serving system for execution by the machine-learned language model;
receiving, from the model serving system, a first-generation response generated by executing the machine-learned language model on the first-generation prompt;
iteratively updating the inference of information related to the concept using the machine-learned language model, comprising:
generating a subsequent-generation prompt for input to the machine-learned language model, the subsequent-generation prompt specifying at least the concept in the first-generation prompt, the raw data from the one or more source documents, and the inference of information related to the concept that are received from a previous-generation response and a subsequent-generation request to update the inference of information related to the concept using at least the inference of information related to the concept that is received from a previous-generation response;
providing the subsequent-generation prompt to the model serving system for execution by the machine-learned language model;
receiving, from the model serving system, a subsequent-generation response generated by executing the machine-learned language model on the subsequent-generation prompt; and
setting the subsequent-generation response as the previous-generation response for a next iteration; and
storing the iteratively updated inference of information related to the concept for retrieval by the machine-learned language model.

16. The computer system of claim 15, wherein the instructions encoded thereon that, when executed by the processor, cause the computer system to perform steps comprising:
receiving, from a client device, a user query;
identifying that the user query is related to a target concept;
generating a prompt for input to the machine-learned language model, the prompt specifying at least the user query, the target concept, stored inference of information related to the target concept, and a request to generate a query response to the user query using at least the stored inference of information related to the target concept as contextual information;
providing the prompt to a model serving system for execution by the machine-learned language model;
receiving, from the model serving system, a response generated by executing the machine-learned language model on the prompt; and
transmitting instructions to the client device to cause presentation of the response including the received query response to the user query.

17. The computer system of claim 15, wherein the instructions to iteratively update the inference of information related to the concept using the machine-learned language model, when executed by the processor, cause the computer system to perform steps comprising:
retrieving, from a graph-structured knowledge base, inferenced information related to the concept.

18. The computer system of claim 17, wherein the instructions to store the iteratively updated inference of information related to the concept for retrieval, when executed by the processor, cause the computer system to perform steps comprising:
storing, at the graph-structured knowledge base, the iteratively updated inference of information related to the concept for retrieval.

19. The computer system of claim 15, wherein the instructions encoded thereon that, when executed by the processor, cause the computer system to perform steps comprising:
identifying terms in the raw data from one or more source documents; and
generating, using the identified terms, one or more embeddings for representing the raw data.

20. The computer system of claim 19, wherein the instructions encoded thereon that, when executed by the processor, cause the computer system to perform steps comprising:
performing a vector search using the one or more embeddings as context information in execution of the machine-learned language model.
